(19) United States
(12) Patent Application Publication
(10) Pub. No.: US 2024/0181564 A1
(43) Pub. Date: Jun. 6, 2024

(54) POWDER-BED LASER PROCESSING APPARATUS, POWDER ADDITIVE MANUFACTURING APPARATUS, PROCESSING METHOD, AND A COMPUTER READABLE MEDIUM

(71) Applicant: THE JAPAN STEEL WORKS, LTD., Shinagawa-ku, Tokyo (JP)

(72) Inventors: Naoki UEDA, Shinagawa-ku, Tokyo (JP); Seiya HIRAMATSU, Shinagawa-ku, Tokyo (JP)

(21) Appl. No.: 18/285,258

(22) PCT Filed: Feb. 8, 2022
(86) PCT No.: PCT/JP2022/004890

§ 371 Date: Oct. 1, 2023

(30) Foreign Application Priority Data
Apr. 22, 2021 (JP) 2021-072289

(51) Int. Cl. B23K 26/082; B23K 26/06; B23K 26/067; B29C 64/153; B29C 64/214; B29C 64/236; B29C 64/282; B33Y 10/00; B33Y 30/00

(52) U.S. Cl. CPC B23K 26/082; B23K 26/0643; B23K 26/0648; B23K 26/0673; B29C 64/153; B29C 64/214; B29C 64/236; B29C 64/282; B33Y 10/00; B33Y 30/00

(57) ABSTRACT

A powder-bed laser processing apparatus includes a first scanning unit, a second scanning unit, a first drive unit, and a second drive unit. The first scanning unit applies first laser light to a powder bed while scanning the first laser light. The second scanning unit applies second laser light to the powder bed while scanning the second laser light. The first drive unit moves the first scanning unit so that the first laser light can be applied to a first irradiation area. The second drive unit moves the second scanning unit so that the second laser light can be applied to a second irradiation area and a position of the second scanning unit relative to the first scanning unit can be changed, the second irradiation area including a part of the first irradiation area.

### TECHNICAL FIELD

The present invention relates to a powder-bed laser processing apparatus, a powder additive manufacturing apparatus, a processing method, and a program.

### BACKGROUND ART

Regarding powder additive manufacturing apparatuses, laser processing apparatuses capable of processing large molding areas have been developed.

For example, as means for expanding the processing range of one laser, a technology for moving a galvano-scanner itself inside a laser apparatus is disclosed (Patent Literature 1).

### CITATION LIST

### Patent Literature

Patent Literature 1: Japanese Unexamined Patent Application Publication No. 2011-240403

### SUMMARY OF INVENTION

### Technical Problem

However, in the above-described technology, it is necessary to perform processing while moving a laser light emission unit relative to a powder bed in order to be able to process a large molding area, so that the processing is inefficient. Further, to solve the above-described problem, a technology in which a plurality of laser light sources are prepared and a different laser light beam is applied to each of different processing areas has been publicly known. However, when such a technology is adopted, the laser power of the laser light sources may vary from one laser light source to another, thus raising a possibility that the accuracy of products may deteriorate. Further, even though a plurality of laser light sources are prepared, a plurality of laser light beams cannot be effectively used when processing is performed for a relatively small molding area, so that some of the laser light beams are wasted in some cases.

The present disclosure has been made to solve the above-described problems, and an object thereof is to provide a powder-bed laser processing apparatus and the like capable of efficiently performing processing for various molding areas.

### Solution to Problem

A powder-bed laser processing apparatus according to the present disclosure includes a first scanning unit, a second scanning unit, a first drive unit, and a second drive unit. The first scanning unit applies first laser light to a powder bed while scanning the first laser light. The second scanning unit applies second laser light to the powder bed while scanning the second laser light. The first drive unit moves the first scanning unit so that the first laser light can be applied to a first irradiation area. The second drive unit moves the second scanning unit so that the second laser light can be applied to a second irradiation area and a position of the second scanning unit relative to the first scanning unit can be changed, the second irradiation area including a part of the first irradiation area.

In a processing method according to the present disclosure, a computer performs a first driving step, a second driving step, a first scanning step, and a second scanning step. In the first driving step, the computer moves a first scanning unit so that first laser light can be applied to a first irradiation area. In the second driving step, the computer moves a second scanning unit so that second laser light can be applied to a second irradiation area and a position of the second scanning unit relative to the first scanning unit can be changed, the second irradiation area including a part of the first irradiation area. In the first scanning step, the computer applies the first laser light to the first irradiation area while scanning the first laser light. In the second scanning step, the computer applies the second laser light to the second irradiation area while scanning the second laser light.

A program according to the present disclosure causes a computer to perform a processing method described below. In a first driving step, the computer moves a first scanning unit so that a first laser light can be applied to a first irradiation area. In a second driving step, the computer moves a second scanning unit so that a second laser light can be applied to a second irradiation area and a position of the second scanning unit relative to the first scanning unit can be changed, the second irradiation area including a part of the first irradiation area. In a first scanning step, the computer applies the first laser light to the first irradiation area while scanning the first laser light. In a second scanning step, the computer applies the second laser light to the second irradiation area while scanning the second laser light.

### Advantageous Effects of Invention

According to the present disclosure, it is possible to provide a powder-bed laser processing apparatus, a powder additive manufacturing apparatus, a processing method, and a program capable of efficiently performing processing for various molding areas.

### BRIEF DESCRIPTION OF DRAWINGS

FIG. 1 is an overall diagram of a powder additive manufacturing apparatus according to an embodiment;

FIG. 2 is a schematic perspective view of a laser processing apparatus according to an embodiment;

FIG. 3 is a schematic perspective view of a processing unit;

FIG. 4 shows a configuration of a scanning unit;

FIG. 5 is a plan view showing routes of laser light;

FIG. 6 is a plan view showing irradiation areas by a processing unit;

FIG. 7 is a plan view showing a first example of a situation in which a laser processing apparatus is manufacturing a manufactured product;

FIG. 8 is a plan view showing a second example of a situation in which a laser processing apparatus is manufacturing a manufactured product;

FIG. 9 is a plan view showing a third example of a situation in which a laser processing apparatus is manufacturing a manufactured product;

FIG. 10 is a block diagram of a powder additive manufacturing apparatus;

FIG. 11 is a block diagram of a laser processing apparatus; and

FIG. 12 is a flowchart showing operations performed by a powder additive manufacturing apparatus.

### DESCRIPTION OF EMBODIMENTS

The present invention will be described hereinafter through embodiments according to the invention, but the invention, which is specified by the claims, is not limited to the below-shown embodiments. Further, all the components/structures described in the embodiments are not necessarily indispensable as means for solving the problem. For clarifying the explanation, the following descriptions and drawings are partially omitted and simplified as appropriate. Note that the same reference numerals (or symbols) are assigned to the same elements throughout the drawings and redundant explanations thereof are omitted as appropriate.

### EMBODIMENTS

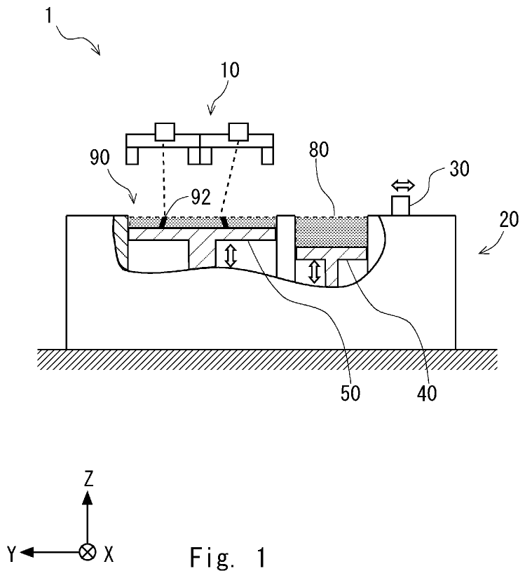

Embodiments according to the present invention will be described hereinafter with reference to the drawings. FIG. 1 is an overall diagram of a powder additive manufacturing apparatus according to an embodiment. The powder additive manufacturing apparatus 1 shown in FIG. 1 is a type of a so-called 3D (three-dimensional) printer, and manufactures a desired 3D shape by forming and stacking a plurality of thinly-sliced 2D (two-dimensional) layers one after another based on 3D design data. FIG. 1 is a side view of the powder additive manufacturing apparatus 1, in which a part of the powder additive manufacturing apparatus 1 is shown in a cross section for the sake of clarifying the explanation. The powder additive manufacturing apparatus 1 includes, as its main components, a powder-bed laser processing apparatus 10 and a main-body block 20.

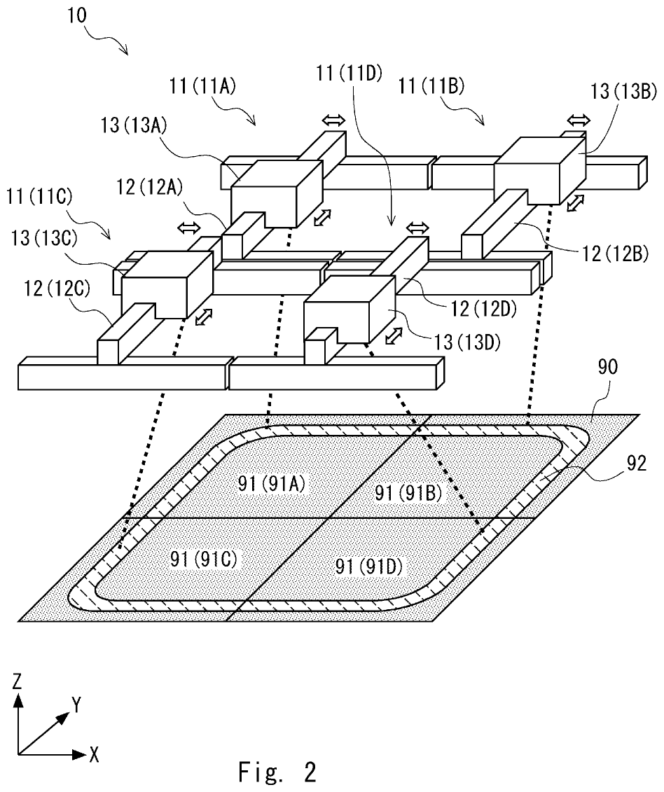

Note that in FIG. 1, a right-handed orthogonal coordinate system is shown for explaining the positional relationship among the components. Further, in FIG. 2 and the subsequent drawings, when an orthogonal coordinate system is shown, the X-, Y-, and Z-axis directions in the orthogonal coordinate system coincide with the X-, Y-, and Z-axis directions, respectively, shown in FIG. 1.

The main-body block 20 will be described hereinafter. The main-body block 20 includes a housing that supports the powder additive manufacturing apparatus 1 over its stationary surface. The main-body block 20 includes, as its main components, a recoater 30, a powder supply part 40, and a powder-bed support part 50.

The recoater 30 sweeps (i.e., pushes sideways and levels) powder 80 supplied from the powder supply part 40 onto a powder bed 90, and then uniformly spreads and levels the powder 80 across the powder bed 90. The recoater 30 includes a plate-like member that is disposed so that it can be moved in a reciprocating manner over the upper surface of the main-body block 20. In the powder additive manufacturing apparatus 1, the powder 80 is spread across the powder bed 90 by having the recoater 30 move from the right side (Y-axis negative side), which corresponds to one end of the powder additive manufacturing apparatus 1, to the left side (Y-axis positive side), which corresponds to the other end of the powder additive manufacturing apparatus 1. That is, in the powder additive manufacturing apparatus 1, the right side in FIG. 1 is the initial position of the recoater 30, and by having the recoater 30 move from this initial position to the left side, the powder 80, which is the material for a product to be manufactured (hereinafter referred to simply as a manufactured product), is spread across the powder bed 90. Note that the plate-like member included in the recoater 30 may be a roller.

The powder supply part 40 supplies a predetermined amount of powder 80 for generating the powder bed 90 to the recoater 30. The powder supply part 40 includes a powder storage part, which is a square-pillar-shaped recess formed in the upper surface of the main-body block 20, and a plate-like member for moving the bottom surface of the powder storage part up and down. The powder supply part 40 pushes up this plate-like member by a preset distance. In this way, the powder supply part 40 supplies the predetermined amount of powder 80 to the recoater 30.

The powder-bed support part 50 is engaged inside a rectangular hole formed in the upper surface of the main-body block 20 in such a manner that the powder-bed support part 50 can be moved up and down. The upper surface of the powder-bed support part 50 is flat, and the powder-bed support part 50 supports the powder bed 90 by this upper surface.

The powder-bed laser processing apparatus 10 is disposed above the powder-bed support part 50 and applies laser light to a desired position on the powder bed 90 formed over the upper surface of the powder-bed support part 50. As the powder-bed laser processing apparatus 10 applies laser light to the powder bed 90, the powder bed 90 melts and then bonds together, so that a manufactured product 92 is formed.

Next, details of the powder-bed laser processing apparatus 10 will be described with reference to FIG. 2. FIG. 2 is a schematic perspective view of a laser processing apparatus according to an embodiment. The powder-bed laser processing apparatus 10 includes, as its main components, a plurality of processing units 11. The powder-bed laser processing apparatus 10 shown in the drawing includes, above the powder bed 90, four processing units 11 each of which corresponds to a respective one of four divided areas 91, which are obtained by dividing the powder bed 90 into two sections in the X-axis direction and then dividing each of these two sections into two sections in the Y-axis direction.

More specifically, a first processing unit 11A is disposed above a first divided area 91A, which is one of the four divided areas 91. Similarly, a second processing unit 11B, a third processing unit 11C, and a fourth processing unit 11D are disposed above a second divided area 91B, a third divided area 91C, and a fourth divided area 91D, respectively. Further, the above-described plurality of processing units 11 are all disposed on a plane parallel to the surface of the powder bed 90.

Note that in the following description, for example, the term “processing unit(s) 11” collectively refers to the first, second, third, and fourth processing units 11A, 11B, 11C, and 11D. Regarding each component or structure included in the processing unit 11, when no symbol corresponding to any of the first, second, third, and fourth processing units 11A, 11B, 11C, and 11D is shown, the component or structure corresponds to a component or structure of any or all of the first, second, third, and fourth processing units 11A, 11B, 11C, and 11D.

The powder-bed laser processing apparatus 10 shown in FIG. 2 is in a state in which it is manufacturing a manufactured product 92 by applying laser light to the powder bed 90. Thick dotted lines in the drawing indicate laser light beams that are applied from the processing units 11 to the powder bed 90. Each of the plurality of processing units 11 has a function of emitting laser light.

For example, the first processing unit 11A includes a first drive unit 12A and a first scanning unit 13A. Similarly, the second processing unit 11B includes a second drive unit 12B and a second scanning unit 13B. The third processing unit 11C includes a third drive unit 12C and a third scanning unit 13C. The fourth processing unit 11D includes a fourth drive unit 12D and a fourth scanning unit 13D. Each of the drive units 12 moves the corresponding scanning unit 13 so that laser light emitted from the scanning unit 13 can be applied to the powder bed 90. Further, the drive units 12 move the scanning units 13 on a common moving surface.

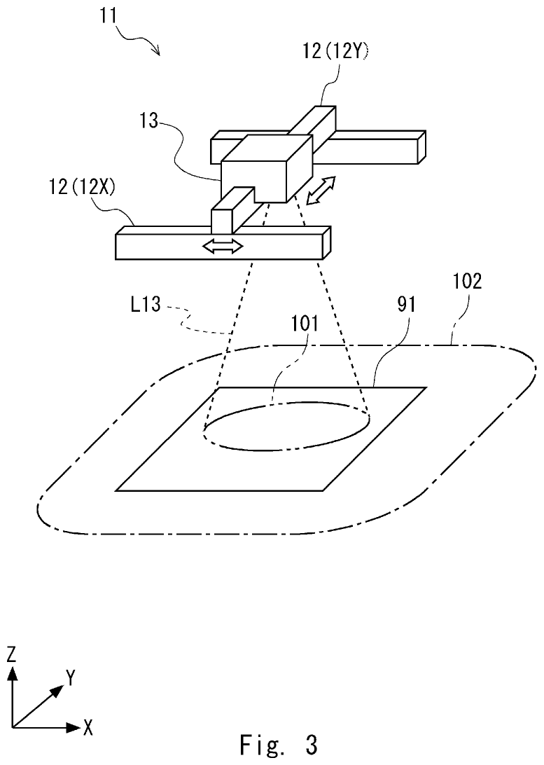

Next, a configuration of the processing unit 11 will be described with reference to FIG. 3. FIG. 3 is a schematic perspective diagram of the processing unit 11. The processing unit 11 includes, as its main components, the drive unit 12 and the scanning unit 13. Further, FIG. 3 shows a divided area 91, a scanning area 101, and an irradiation possible range 102 located below the processing unit 11.

The drive unit 12 is disposed above the divided area 91 by an arbitrary support member (not shown). The drive unit 12 includes a gantry mechanism including a first conveyance part 12X and a second conveyance part 12Y. The gantry mechanism is an embodiment of the drive unit 12.

The first conveyance part 12X is fixed to an arbitrary support member, includes a guide rail extending in the X-axis direction, and supports the second conveyance part 12Y in such a manner that the second conveyance part 12Y can be linearly moved in the X-axis direction. That is, the first conveyance part 12X conveys the scanning unit 13 in a first direction (X-direction) parallel to the surface of the powder bed 90. The second conveyance part 12Y is supported on the first conveyance part 12X, includes a guide rail extending in the Y-axis direction, and supports the scanning unit 13 in such a manner that the scanning unit 13 can be linearly moved in the Y-axis direction. That is, the second conveyance part 12Y conveys the scanning unit 13 in a second direction (Y-direction) that is parallel to the surface of the powder bed 90 but is different from the first direction.

Next, a laser light irradiation area of the processing unit 11 will be described with reference to FIG. 3. The scanning unit 13 applies laser light L13 to the powder bed while scanning the laser light L13 (i.e., while repeatedly changing the direction of the laser light L13 in a reciprocating manner). The scanning unit 13 scans the laser light L13 (i.e., repeatedly changes the direction of the laser light L13 in a reciprocating manner) within the range of the scanning area 101. That is, the scanning area 101 indicates an area where the laser light L13 can be applied even when the position of the scanning unit 13 is not changed.

Further, the drive unit 12 moves the scanning unit 13 so that the scanning unit 13 can apply the laser light L13 to any part of the irradiation possible range 102. The irradiation possible range 102 is defined so as to include the divided area 91 therein. In other words, the irradiation possible range 102 is defined so that the laser light L13 can be applied to an area that includes and is larger than the divided area 91. As described above, the powder-bed laser processing apparatus 10 is configured so that laser light can be applied to a larger area by moving the scanning unit 13.

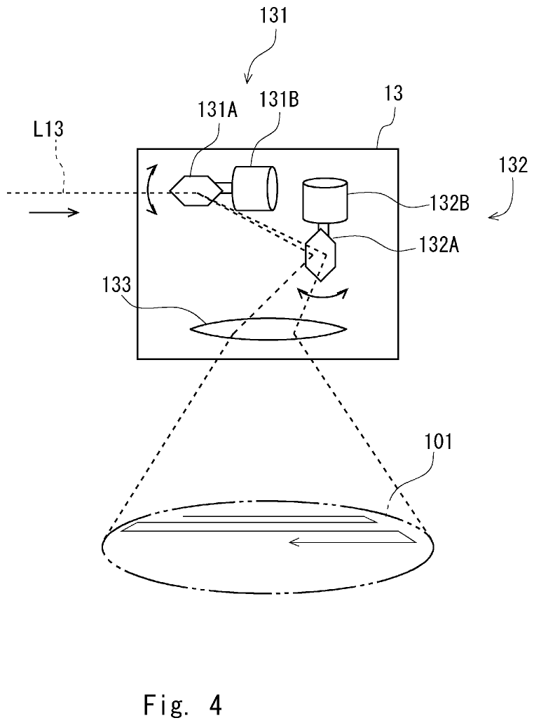

Next, the scanning unit 13 will be further described with reference to FIG. 4. FIG. 4 shows a configuration of the scanning unit. The scanning unit 13 includes, as its main components, a first galvano unit 131, a second galvano unit 132, and a lens 133. The scanning unit 13 includes the first and second galvano units 131 and 132 as an embodiment of the scanning unit that receives laser light and scans the received laser light (i.e., redirects the received laser light while repeatedly changing the direction of the redirected laser light in a reciprocating manner).

The first galvano unit 131 includes a mirror 131A that reflects laser light and a mirror drive unit 131B that turns (or rotates) this mirror in a reciprocating manner in a predetermined angle range around a predetermined axis. The first galvano unit 131 receives laser light L13 from the outside, reflects the received laser light L13 to the mirror 131A, and thereby supplies the reflected laser light L13 to the second galvano unit 132.

Like the first galvano unit 131, the second galvano unit 132 also includes a mirror 132A that reflects laser light and a mirror drive unit 132B that turns (or rotates) this mirror in a reciprocating manner in a predetermined angle range around a predetermined axis. Further, the axis around which the mirror of the first galvano unit 131 turns and the axis around which the mirror of the second galvano unit 132 turns are set so that they are perpendicular to each other. The second galvano unit 132 reflects the laser light L13 supplied from the first galvano unit 131 to the mirror 132A, and thereby supplies the reflected laser light L13 to the lens 133.

The lens 133 receives the laser light scanned by the first and second galvano units 131 and 132 and applies the received laser light to the powder bed 90. The lens 133 is a certain optical lens and applies the laser light L13 supplied from the second galvano unit 132 to the powder bed 90. By the above-described configuration, the scanning unit 13 applies the laser light L13, which has originally been supplied from the outside, to the scanning area 101 while scanning the laser light L13 (i.e., while repeatedly changing the direction of the laser light L13 in a reciprocating manner). Note that the lens 133 may be formed by combining a plurality of lenses.

Note that each of the galvano units provided in the scanning unit 13 may include a galvano-motor as a mechanism for turning the mirror in a reciprocating manner, or may be a MEMS (Micro Electro Mechanical Systems) mirror driver in the case where the mirror is formed by a MEMS technology. The scanning unit 13 may include a configuration by which the relative positional relationship between the galvano unit and the lens 133 is changed. By changing the positions of the galvano unit and the lens 133, the powder-bed laser processing apparatus 10 can expand the scanning area 101 of the scanning unit 13.

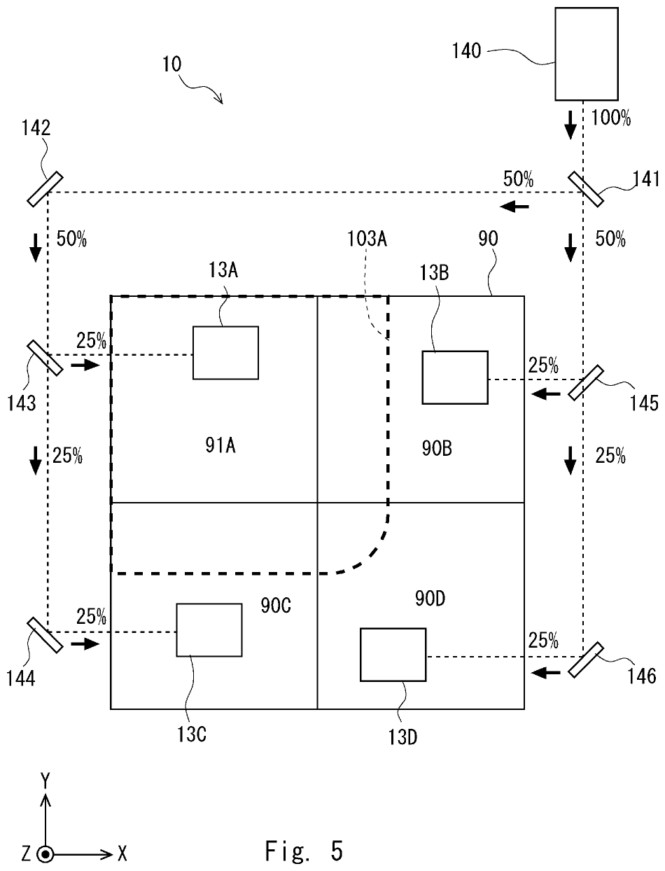

Next, a configuration for supplying laser light in the powder-bed laser processing apparatus 10 and the irradiation area of the scanning unit 13 will be described with reference to FIG. 5. FIG. 5 is a plan view showing routes of laser light. The powder-bed laser processing apparatus 10 includes, as a configuration for supplying laser light to the scanning unit 13, a laser light source 140, a partial reflection mirror 141, a total reflection mirror 142, a partial reflection mirror 143, a total reflection mirror 144, a partial reflection mirror 145, and a total reflection mirror 146.

The laser light source 140 includes, for example, a carbon dioxide laser oscillation device that oscillates (i.e., generates) and emits carbon dioxide laser. The laser light source 140 supplies the laser light to the partial reflection mirror 141. The partial reflection mirror 141 reflects part of the laser light received from the laser light source 140 and supplies the reflected laser light to the total reflection mirror 142. Further, the partial reflection mirror 141 lets part of the laser light received from the laser light source 140 pass therethrough, and supplies the laser light, which has passed through the partial reflection mirror 141, to the partial reflection mirror 145.

The total reflection mirror 142 reflects the laser light received from the partial reflection mirror 141 and supplies the reflected laser light to the partial reflection mirror 143. The partial reflection mirror 143 reflects part of the laser light received from the total reflection mirror 142 and supplies the reflected laser light to the first scanning unit 13A corresponding to the first divided area 91A. Further, the partial reflection mirror 143 lets part of the laser light received from the total reflection mirror 142 pass therethrough, and supplies the laser light, which has passed through the partial reflection mirror 143, to the total reflection mirror 144. The total reflection mirror 144 reflects the laser light received from the partial reflection mirror 143 and supplies the reflected laser light to the third scanning unit 13C corresponding to the third divided area 91C.

The partial reflection mirror 145 reflects part of the laser light received from the partial reflection mirror 141 and supplies the reflected laser light to the second scanning unit 13B corresponding to the second divided area 91B. Further, the partial reflection mirror 145 lets part of the laser light received from the partial reflection mirror 141 pass therethrough, and supplies the laser light, which has passed through the partial reflection mirror 145, to the total reflection mirror 146. The total reflection mirror 146 reflects the laser light received from the partial reflection mirror 145 and supplies the reflected laser light to the fourth scanning unit 13D corresponding to the fourth divided area 91D.

By the above-described configuration, the powder-bed laser processing apparatus 10 divides the laser light generated by the laser light source 140 into four laser light beams, and supplies the four divided laser light beams to the four scanning units 13, respectively. Note that the reflectance or transmittance of the partial reflection mirrors in the above-described configuration are adjusted so that the laser power supplied to the four scanning units 13 is equal to each other.

In the above-described example, when the laser power of the laser light output from the laser light source 140 is defined as 100%, the laser power of the laser light that has passed through or is reflected by the partial reflection mirror 141 is 50%. Further, the laser power of the laser light that has passed through or is reflected by the partial reflection mirror 143 is 25%. Similarly, the laser power of the laser light that has passed through or is reflected by the partial reflection mirror 145 is 25%. As a result, each of the scanning units 13 receives 25% of the laser power of the original laser light.

By dividing laser light generated by one laser light source and supplying the divided laser light to a plurality of scanning units 13 as described above, the powder-bed laser processing apparatus 10 can reduce variations in the laser power among the plurality of scanning units 13. Therefore, the powder additive manufacturing apparatus 1 can efficiently manufacture manufactured products of which variations in the size is small.

Note that the above-described configuration of mirrors is merely an example in the powder-bed laser processing apparatus 10, and the configuration of mirrors in the powder-bed laser processing apparatus 10 is not limited to the above-described example. Further, in the above-described configuration of mirrors, each of the partial reflection mirror 143, the total reflection mirror 144, the partial reflection mirror 145, and the total reflection mirror 146 can be designed so that it can follow the movement of the scanning unit 13, which supplies the laser light.

Next, the irradiation area of the scanning unit 13 will be described. In FIG. 5, an area indicated by a thick dotted line is a first irradiation area 103A. The first irradiation area 103A is an area corresponding to the range of the powder bed 90 in the irradiation possible range 102 of the first scanning unit 13A. That is, the first irradiation area 103A is an area where the first scanning unit 13A can apply laser light to the powder bed 90. The first irradiation area 103A includes a first divided area 91A, and also includes a part of each of the second, third, and fourth divided areas 91B, 91C, and 91D adjacent to the first divided area 91A.

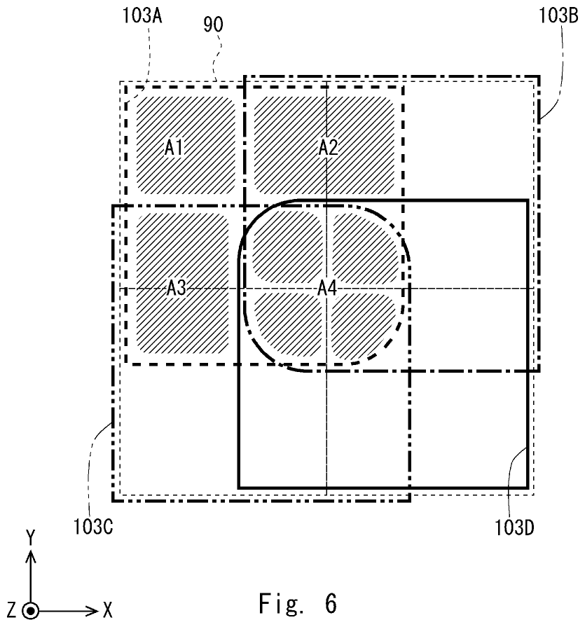

The irradiation area will be further described with reference to FIG. 6. FIG. 6 is a plan view showing an irradiation area of a processing unit. FIG. 6 shows a second irradiation area 103B, a third irradiation area 103C, and a fourth irradiation area 103D in addition to the first irradiation area 103A. The second irradiation area 103B is an area where the second scanning unit 13B can apply laser light to the powder bed 90. The third irradiation area 103C is an area where the third scanning unit 13C can apply laser light to the powder bed 90. The fourth irradiation area 103D is an area where the fourth scanning unit 13D can apply laser light to the powder bed 90. As shown in the drawing, there is an overlapped area between any two of the first to fourth irradiation areas 103A to 103D.

For example, the first irradiation area 103A includes a first processing area A1, a second processing area A2, a third processing area A3, and a fourth processing area A4 shown in the drawing. The first processing area A1 is an area that is included in the first irradiation area 103A and does not overlap any of the other irradiation areas. That is, the first processing area A1 is an area where laser light can be applied only by the first scanning unit 13A.

The second processing area A2 is an area where the first and second irradiation areas 103A and 103B overlap each other. That is, the second processing area A2 is an area where laser light can be applied by either of the first and second scanning units 13A and 13B.

The third processing area A3 is an area where the first and third irradiation areas 103A and 103C overlap each other. That is, the third processing area A3 is an area where laser light can be applied by either of the first and third scanning units 13A and 13C.

The fourth processing area A4 is an area where the first, second, third, and fourth irradiation areas 103A, 103B, 103C, and 103D overlap each other. That is, the fourth processing area A4 is an area where laser light can be applied by any of the first, second, third, and fourth scanning units 13A, 13B, 13C, and 13D.

As described above, in the powder-bed laser processing apparatus 10, parts of a plurality of laser light irradiation areas of the respective scanning units 13 overlap each other. For example, the first drive unit 12A moves the first scanning unit 13A so that laser light emitted by the first scanning unit 13A can be applied to the first irradiation area. Then, the second drive unit 12B moves the second scanning unit 13B so that laser light emitted by the second scanning unit 13B can be applied to the second irradiation area including a part of the first irradiation area. Further, the first and second drive units 12A and 12B move the first and second scanning units 13A and 13B so that the relative positions of the first and second scanning units 13A and 13B can be changed. By the above-described configuration, the powder-bed laser processing apparatus 10 can efficiently manufacture manufactured products having various sizes and various shapes.

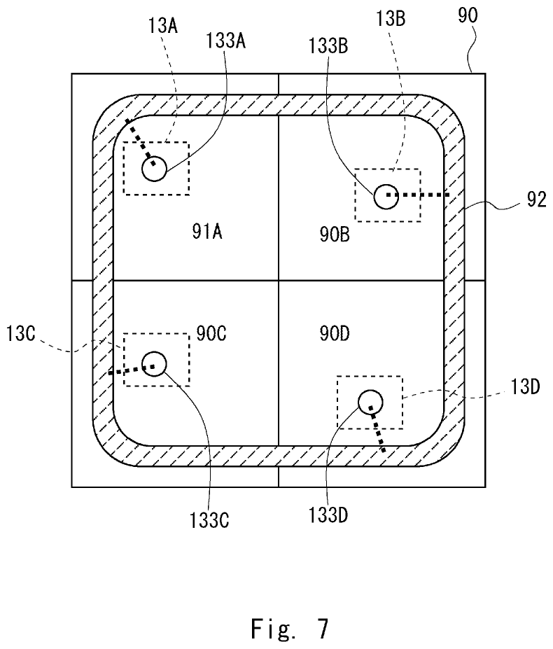

Next, an example of a manufactured product manufactured by the powder-bed laser processing apparatus 10 will be described. FIG. 7 is a plan view showing a first example of a situation in which a manufactured product is being manufactured. For facilitating the understanding, FIG. 7 shows the position of the lens 133 included in each of a plurality of scanning units 13 and laser light emitted from the lens of each of the plurality of scanning units 13 over the powder bed 90 in a superimposed manner.

FIG. 7 shows a situation in which a manufactured product 92 is being manufactured in the powder bed 90. The manufactured product 92 is a relatively large one extending over parts of the first divided area 91A, the second divided area 91B, the third divided area 91C, and the fourth divided area 91D. In order to manufacture the manufactured product 92, the powder-bed laser processing apparatus 10 puts the first scanning unit 13A in charge of the processing (i.e., the application of laser light) in the first divided area 91A. Similarly, the powder-bed laser processing apparatus 10 puts the second, third, and fourth scanning units 13B, 13C, and 13D in charge of the processing in the second, third, and fourth divided area 91B, 91C, and 91D, respectively. By the above-described method, the powder-bed laser processing apparatus 10 efficiently manufactures the manufactured product 92 by putting the four scanning units 13 in charge of the equally-divided processing areas, respectively.

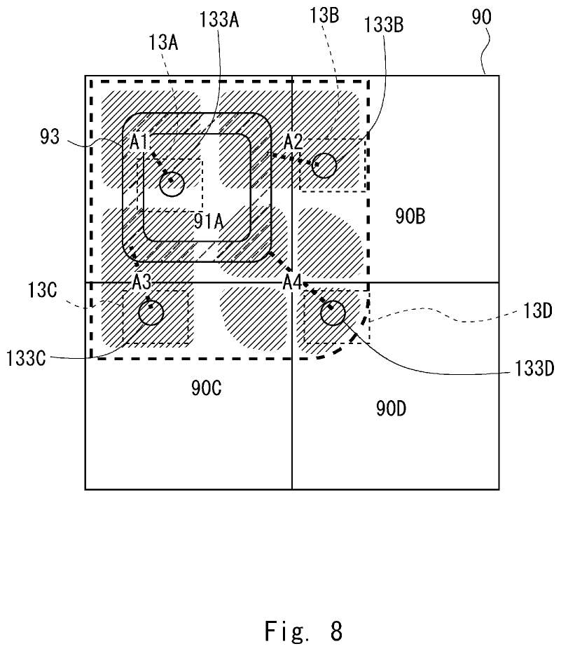

Next, another example of the case where the powder-bed laser processing apparatus 10 manufactures a manufactured product will be described with reference to FIG. 8. FIG. 8 is a plan view showing a second example of a situation in which the laser processing apparatus is manufacturing a manufactured product. FIG. 8 shows a situation in which a manufactured product 93 is being manufactured in the powder bed 90. The manufactured product 93 is a relatively small one that can be fit in the first divided area 91A.

In the above-described situation, the powder-bed laser processing apparatus 10 puts the first scanning unit 13A in charge of the processing in the first processing area A1 of the first divided area 91A in order to manufacture the manufactured product 93. Further, the powder-bed laser processing apparatus 10 puts the second, third, and fourth scanning units 13B, 13C, and 13D in charge of the processing in the second, third, and fourth processing area A2, A3, and A4, respectively. By the above-described method, the powder-bed laser processing apparatus 10 efficiently manufactures the manufactured product 93 by putting the four scanning units 13 in charge of the divided processing areas, respectively.

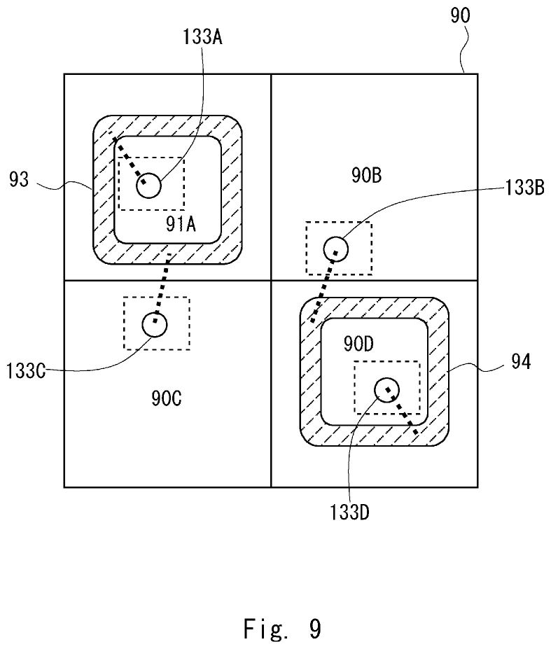

Next, FIG. 9 will be described. FIG. 9 is a plan view showing a third example of a situation in which the laser processing apparatus is manufacturing a manufactured product. FIG. 9 shows a situation in which a manufactured product 93 and a manufactured product 94 are being manufactured in the powder bed 90. The manufactured product 93 is manufactured in the first divided area 91A. Further, the manufactured product 94 has roughly the same size as that of the manufactured product 93 and is manufactured in the fourth divided area 91D.

In the above-described situation, the powder-bed laser processing apparatus 10 puts, for example, the first and third scanning units 13A and 13C in charge of the processing of the manufactured product 93 in the first divided area 91A. Further, the powder-bed laser processing apparatus 10 puts, for example, the second and fourth scanning units 13B and 13D in charge of the processing of the manufactured product 94 in the fourth divided area 91D. In this way, the powder-bed laser processing apparatus 10 efficiently manufactures the manufactured products 93 and 94.

Examples of processing methods performed by the powder-bed laser processing apparatus 10 have been described above with reference to FIGS. 7, 8 and 9. As described above, the powder-bed laser processing apparatus 10 can efficiently use a plurality of scanning units 13 for manufactured products having various sizes.

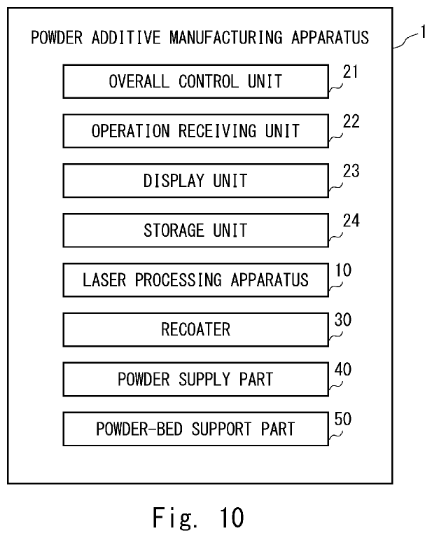

Next, a functional configuration of the powder additive manufacturing apparatus 1 will be described with reference to FIG. 10. FIG. 10 is a block diagram of the powder additive manufacturing apparatus. The powder additive manufacturing apparatus 1 includes, as its main components, an overall control unit 21, an operation receiving unit 22, a display unit 23, a powder-bed laser processing apparatus 10, a recoater 30, a powder supply part 40, and a powder-bed support part 50. Note that the components shown in FIG. 10 are connected with each other as appropriate by certain communication means so that they can communicate with each other.

The overall control unit 21 includes an arithmetic unit such as a CPU (Central Processing Unit) or an MPU (Micro Processing Unit), is connected to each of the other components of the powder additive manufacturing apparatus 1 so that they can communicate with each other, and controls the whole powder additive manufacturing apparatus 1. For example, when the overall control unit 21 receives, from a user, an instruction to manufacture a manufactured product, it manufactures the manufactured product by controlling the powder-bed laser processing apparatus 10, the recoater 30, the powder supply part 40, and the powder-bed support part 50 according to the size and shape of the manufactured product.

The operation receiving unit 22 is a user interface including, for example, a keyboard, buttons, a touch panel, and the like. The operation receiving unit 22 receives an operation from a user who is using the powder additive manufacturing apparatus 1 and provides a signal for the received operation to the overall control unit 21. The display unit 23 includes a display device such as a liquid-crystal panel, an organic electroluminescent panel, or LEDs (light-emitting diodes), and notifies the user of information about the operating status and the like of the powder additive manufacturing apparatus 1.

The storage unit 24 is a storage device including a nonvolatile memory and stores, for example, a program(s) executed by the powder additive manufacturing apparatus 1. When the powder additive manufacturing apparatus 1 is started up, the storage unit 24 may supply the stored program (s) to the overall control unit 21.

The powder-bed laser processing apparatus 10 shown in the drawing will be described later. Each of the recoater 30, the powder supply part 40, and the powder-bed support part 50 is configured so that it can operate in response to an instruction from the overall control unit 21. For example, each of the recoater 30, the powder supply part 40, and the powder-bed support part 50 includes a sensor for monitoring its operating state, a motor for performing the operation, a motor driver for driving this motor, and the like.

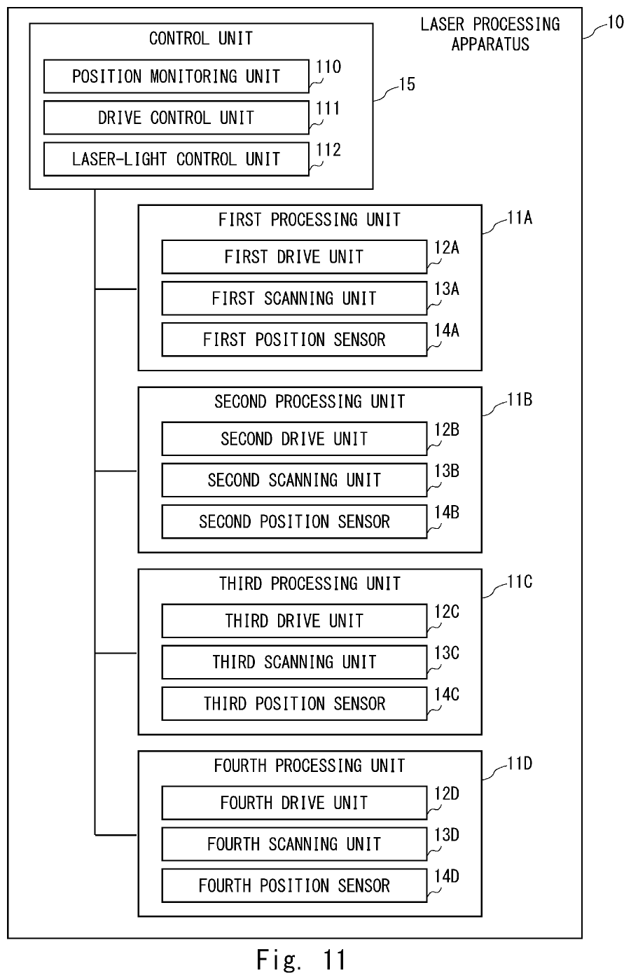

Next, the functional configuration of the powder-bed laser processing apparatus 10 will be further described with reference to FIG. 11. FIG. 11 is a block diagram of the powder-bed laser processing apparatus 10. The powder-bed laser processing apparatus 10 includes, as its main components, a control unit 15, a first processing unit 11A, a second processing unit 11B, a third processing unit 11C, and a fourth processing unit 11D.

The control unit 15 controls a plurality of scanning units 13 provided in the powder-bed laser processing apparatus 10. The control unit 15 includes, as its main components, a position monitoring unit 110, a drive control unit 111, and a laser-light control unit 112.

The position monitoring unit 110 monitors the positions of the first, second, third, and fourth scanning units 13A, 13B, 13C, and 13D. More specifically, the position monitoring unit 110 acquires data on the position of the first scanning unit 13A from the first position sensor 14A provided in the first processing unit 11A. Similarly, the position monitoring unit 110 acquires, from the second position sensor 14B provided in the second processing unit 11B, the third position sensor 14C provided in the third processing unit 11C, and the fourth position sensor 14D provided in the fourth processing unit 11D, data on the positions of their respective scanning units 13. When the position monitoring unit 110 acquires data on the position of each of these scanning units 13, it supplies the acquired data to the drive control unit 111.

The drive control unit 111 includes an arithmetic unit such as a CPU or an MPU. The drive control unit 111 also includes a volatile or nonvolatile storage device and executes a predetermined program(s). In this way, the drive control unit 111 controls the operations performed by the first, second, third, and fourth drive units 12A, 12B, 12C, and 12D in cooperation with the position monitoring unit 110. That is, the drive control unit 111 receives the data on the position of each of the scanning units 13 from the position monitoring unit 110 and supplies a signal for instructing each of the drive units 12 to drive the motor or the like according to the received data. Further, when the scanning unit 13 moves to a set position, the drive control unit 111 also cooperates with the laser-light control unit 112 and applies laser light to the corresponding irradiation area while scanning the laser light. The laser-light control unit controls the oscillation of laser light generated in the laser light source 140 according to the instruction from the drive control unit 111.

The first processing unit 11A includes, as its main components, a first drive unit 12A, a first scanning unit 13A, and a first position sensor 14A. The first drive unit 12A includes a motor for moving the first scanning unit 13A. The first drive unit 12A may include a motor driver for driving this motor. The first scanning unit 13A includes a drive unit for driving the scanner, which applies laser light to the powder bed 90 while scanning the laser light, and a driver for driving this drive unit. The drive unit for driving the scanner is, for example, a galvano-motor. Further, in the case where the scanner is formed by a MEMS mirror(s), the drive unit is a MEMS mirror driver(s). The first position sensor 14A is a sensor for detecting the position of the first scanning unit 13A, such as a linear position sensor or an encoder for detecting the operating state of the motor.

The second processing unit 11B includes, as its main components, a second drive unit 12B, a second scanning unit 13B, and a second position sensor 14B. The third processing unit 11C includes, as its main components, a third drive unit 12C, a third scanning unit 13C, and a third position sensor 14C. The fourth processing unit 11D includes, as its main components, a fourth drive unit 12D, a fourth scanning unit 13D, and a fourth position sensor 14D. The configuration of each of the second, third, and fourth processing units 11B, 11C, and 11D is roughly the same as the above-described configuration of the first processing unit 11A.

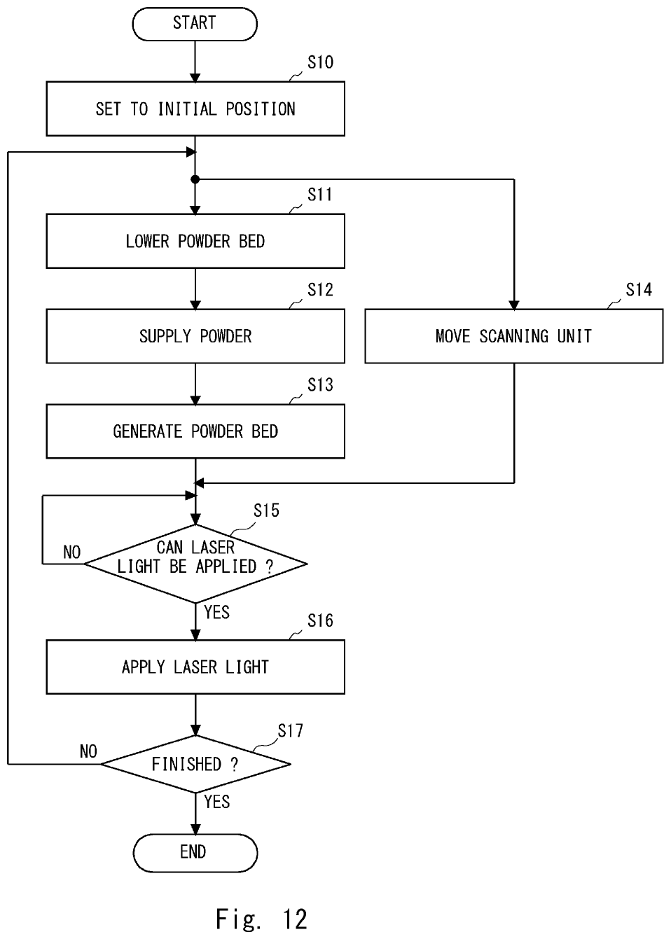

Next, processes performed by the powder additive manufacturing apparatus 1 will be described with reference to FIG. 12. FIG. 12 is a flowchart showing operations performed by the powder additive manufacturing apparatus 1. The flowchart shown in FIG. 12 starts, for example, when the powder additive manufacturing apparatus 1 is started up.

Firstly, the overall control unit 21 of the powder additive manufacturing apparatus 1 sets each of the components of the powder additive manufacturing apparatus 1 to its initial position (Step S10). The initial position is the initial position of the operation when the manufacturing of a manufactured product starts. For example, the initial position of the recoater 30 is the rightmost position in the main-body block 20 shown in FIG. 1. Further, the initial position of the powder supply part 40 is a position where the upper surface of the powder 80 coincides with the upper surface of the main-body block 20. Further, the initial position of the powder-bed support part 50 is a position where the surface on which the powder bed 90 is generated coincides with the upper surface of the main-body block 20. When each of the components has been set to its initial position, the overall control unit 21 performs processes in steps S11 to S13 and a process in a step S14 in parallel (i.e., simultaneously with each other).

The processes in the steps S11 to S13 will be described hereinafter. The overall control unit 21 lowers the powder-bed support part 50 by a distance equivalent to one layer of the powder bed 90 (Step S11). Next, the overall control unit 21 makes the powder supply part 40 supply an amount of powder 80 corresponding to one layer of the powder bed 90 to the powder supply part 40 (Step S12). Next, the overall control unit 21 spreads the powder 80 supplied from the powder supply part 40 across the powder bed 90 by moving the recoater 30 and thereby generates the powder bed 90 (Step S13). The steps S11 to S13 have been described above.

In the step S14, the overall control unit 21 moves the scanning units 13 of the powder-bed laser processing apparatus 10 to a predetermined position (Step S14). More specifically, the overall control unit 21 indicates, to the drive control unit 111 of the powder-bed laser processing apparatus 10, the position of each of the scanning units 13. The drive control unit 111 moves the first to fourth scanning units 13A to 13D in response to the instruction (i.e., the indication) received from the overall control unit 21.

Next, the overall control unit 21 determines whether or not it is possible to apply laser light (Step S15). More specifically, the overall control unit 21 determines that it is possible to apply laser light when it detects (i.e., determines) that all the above-described processes in the steps S11 to S13 and the process in the step S14 have been completed, and does not determine that it is possible to apply laser light when any of the above-described processes has not been completed yet. When the overall control unit 21 has not determined that it is possible to apply laser light (Step S15: No), it repeats the step S15. When the overall control unit 21 has determined that it is possible to apply laser light (Step S15: Yes), it proceeds to a step S16.

In the step S16, the overall control unit 21 instructs the powder-bed laser processing apparatus 10 to apply laser light (Step S16). When the powder-bed laser processing apparatus 10 receives the above-described instruction, the laser-light control unit 112 applies laser light to the irradiation area while scanning the laser light.

Next, the overall control unit 21 determines whether or not the process has been finished (Step S17). When the overall control unit 21 has not determined that the process has been finished (Step S17: No), it returns to the processes in the steps S11 and S14. When the overall control unit 21 has determined that the process has been finished (Step S17: Yes), it finishes the series of processes.

The processes performed by the powder additive manufacturing apparatus 1 have been described above. The flowchart shown in FIG. 11 includes a processing method performed by the powder-bed laser processing apparatus 10. That is, the powder-bed laser processing apparatus 10 moves the scanning units 13 so that they can apply laser light to their respective irradiation areas (Step S14), and apply laser light to the respective irradiation areas while scanning the laser light (Step S16).

Further, in the above-described processes, the first to fourth drive units 12A to 12D move the scanning units 13 during the period in which the powder-bed support part lowers the powder bed or the recoater drives (i.e., operates) (i.e., the period from the step S11 to the step S13) (Step S14). Through the above-described processes, the powder-bed laser processing apparatus 10 can manufacture a manufactured product by efficiently moving the scanning units 13.

The embodiments have been described above. As described above, according to the embodiments, it is possible to provide a powder-bed laser processing apparatus, a powder additive manufacturing apparatus, a processing method, and a program capable of efficiently performing processing for various molding areas.

Note that the aforementioned program may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), CD-R, CD-R/W, and a semiconductor memory (such as a mask ROM, a PROM (Programmable ROM), an EPROM (Erasable PROM), a flash ROM, and a RAM (Random Access Memory). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

Although the embodiments have been described above, the configurations of the powder-bed laser processing apparatus 10 and the powder additive manufacturing apparatus 1 according to embodiments are not limited to the above-described configurations. For example, the number of scanning units 13 does not have to be four, but may be any number equal to or greater than two. The powder-bed laser processing apparatus 10 may be one that includes a plurality of laser light sources and supplies (i.e., applies) laser light from the plurality of laser light sources to scanning units 13.

Note that the present invention is not limited to the above-described embodiments, and they can be modified as appropriate without departing from the scope and spirit of the invention.

This application is based upon and claims the benefit of priority from Japanese patent application No. 2021-072289, filed on Apr. 22, 2021, the disclosure of which is incorporated herein in its entirety by reference.

### REFERENCE SIGNS LIST

1 POWDER ADDITIVE MANUFACTURING APPARATUS
10 POWDER BED LASER PROCESSING APPARATUS
11 PROCESSING UNIT
12 DRIVE UNIT
12X FIRST CONVEYANCE UNIT
12Y SECOND CONVEYANCE UNIT
13 SCANNING UNIT
14 POSITION SENSOR
15 CONTROL UNIT
20 MAIN-BODY BLOCK
21 OVERALL CONTROL UNIT
22 OPERATION RECEIVING UNIT
23 DISPLAY UNIT
24 STORAGE UNIT
30 RE-COATER
40 POWDER SUPPLY PART
50 POWDER-BED SUPPORT PART
80 POWDER
90 POWDER BED
91 DIVIDED AREA
92 MANUFACTURED PRODUCT
93 MANUFACTURED PRODUCT
94 MANUFACTURED PRODUCT
101 SCANNING AREA
102 IRRADIATION POSSIBLE AREA
103 IRRADIATION AREA
110 POSITION MONITORING UNIT
111 DRIVE CONTROL UNIT
112 LASER-LIGHT CONTROL UNIT
131 FIRST GALVANO UNIT
132 SECOND GALVANO UNIT
133 LENS
140 LASER LIGHT SOURCE
141 PARTIAL REFLECTION MIRROR
142 TOTAL REFLECTION MIRROR
143 PARTIAL REFLECTION MIRROR
144 TOTAL REFLECTION MIRROR
145 PARTIAL REFLECTION MIRROR
146 TOTAL REFLECTION MIRROR

1. A powder-bed laser processing apparatus comprising:
a first scanning unit configured to apply first laser light to a powder bed while scanning the first laser light;
a second scanning unit configured to apply second laser light to the powder bed while scanning the second laser light;
a first drive unit configured to move the first scanning unit so that the first laser light can be applied to a first irradiation area; and
a second drive unit configured to move the second scanning unit so that the second laser light can be applied to a second irradiation area and a position of the second scanning unit relative to the first scanning unit can be changed, the second irradiation area including a part of the first irradiation area.

2. The powder-bed laser processing apparatus according to claim 1, further comprising:
a laser light source configured to emit laser light; and
a partial reflection mirror configured to receive the laser light from the laser light source and divide the laser light into laser light supplied to the first scanning unit and laser light supplied to the second scanning unit.

3. The powder-bed laser processing apparatus according to claim 1, wherein each of the first and second scanning units comprises:
a scanning unit configured to receive laser light and scan the received laser light; and
a lens configured to receive the laser light scanned by the scanning unit and apply the received laser light to the powder bed.

4. The powder-bed laser processing apparatus according to claim 1, wherein the first and second drive units move the first and second scanning units, respectively, on a common moving surface.

5. The powder-bed laser processing apparatus according to claim 1, wherein the first and second drive units comprise:
first conveyance units configured to convey the first and second scanning units, respectively, in a first direction parallel to a surface of the powder bed; and
second conveyance units configured to convey the first and second scanning units, respectively, in a second direction, the second direction being parallel to the surface of the powder bed and different from the first direction.

6. The powder-bed laser processing apparatus according to claim 5, wherein each of the first and second drive units is a gantry mechanism including a guide rail extending in each of the first and second directions.

7. The powder-bed laser processing apparatus according to claim 1, further comprising:
a position control unit configured to control positions of the first and second scanning units; and
a drive control unit configured to control operations performed by the first and second drive units in cooperation with the position control unit.

8. A powder additive manufacturing apparatus comprising:
a powder-bed laser processing apparatus according to claim 1;
a powder-bed support part configured to support the powder bed; and
a recoater configured to spread powder across the powder bed.

9. The powder additive manufacturing apparatus according to claim 8, wherein the first and second drive units move the first and second scanning units during a period in which the powder-bed support part lowers the powder bed or the recoater drives.

10. A processing method in which a computer performs:
a first driving step of moving a first scanning unit so that first laser light can be applied to a first irradiation area;
a second driving step of moving a second scanning unit so that second laser light can be applied to a second irradiation area and a position of the second scanning unit relative to the first scanning unit can be changed, the second irradiation area including a part of the first irradiation area;
a first scanning step of applying the first laser light to the first irradiation area while scanning the first laser light; and
a second scanning step of applying the second laser light to the second irradiation area while scanning the second laser light.

11. A non-transitory computer readable medium storing a control program for causing a computer to perform a processing method, the processing method comprising the steps including:
a first driving step of moving a first scanning unit so that first laser light can be applied to a first irradiation area;
a second driving step of moving a second scanning unit so that second laser light can be applied to a second irradiation area and a position of the second scanning unit relative to the first scanning unit can be changed, the second irradiation area including a part of the first irradiation area;
a first scanning step of applying the first laser light to the first irradiation area while scanning the first laser light; and
a second scanning step of applying the second laser light to the second irradiation area while scanning the second laser light.
